(19) United States
(12) Patent Application Publication
(10) Pub. No.: US 2026/0038414 A1
(43) Pub. Date: Feb. 5, 2026

(54) LIGHT SOURCE DEVICE AND DISPLAY APPARATUS

(71) Applicant: SAMSUNG ELECTRONICS CO., LTD., Suwon-si (KR)

(72) Inventors: Seungyong SHIN, Suwon-si (KR); Jungmo KANG, Suwon-si (KR); Myungjoon KIM, Suwon-si (KR); Sujin KIM, Suwon-si (KR); Hyungjin KIM, Suwon-si (KR)

(73) Assignee: SAMSUNG ELECTRONICS CO., LTD., Suwon-si (KR)

(21) Appl. No.: 19/272,365

(22) Filed: Jul. 17, 2025

Related U.S. Application Data
(63) Continuation of application No. PCT/KR2025/008607, filed on Jun. 20, 2025.

(30) Foreign Application Priority Data
Aug. 5, 2024 (KR) 10-2024-0103627

(51) Int. Cl. G09G 3/20

(52) U.S. Cl. CPC G09G 3/2092; G09G 2310/08; G09G 2320/0233

(57) ABSTRACT

There is provided a light source device and a display apparatus with the light source device including scan groups each including a driving element for controlling at least one light source, a plurality of scan lines configured to transmit scan signals to the plurality of scan groups, a data line configured to transmit a data signal to the plurality of scan groups, and a controller configured to determine a generation time point of the scan signal and a cycle of the data signal based on a number of scan groups.

### CROSS-REFERENCE TO RELATED APPLICATIONS

This application is a continuation of International Application No. PCT/KR2025/008607, filed on Jun. 20, 2025, which is based on and claims priority to Korean Patent Application No. 10-2024-0103627, filed on Aug. 5, 2024, in the Korean Intellectual Property Office, the disclosures of which are incorporated by reference herein in their entireties.

### BACKGROUND

### 1. Field

The present disclosure relates to a light source device and a display apparatus that output light by using a plurality of light sources.

### 2. Description of Related Art

A display apparatus is an output device that converts electrical information, which is received from an external device or stored in the display apparatus, into visual information and displays the visual information.

LCD (liquid crystal display) based display apparatuses, OLED (organic light emitting diode) based display apparatuses, mini-LED (Light Emitting Diode) based display apparatuses, micro-LED-based display apparatuses, and the like are widely used as the display apparatuses.

Recently, a plurality of driving elements and a plurality of light sources (e.g., light-emitting diodes) have been used in display apparatuses to implement high contrast ratios and improve image quality.

The driving elements and the light sources may be disposed on substrates by a surface mount technology (SMT) and connected to one another by lines on the substrates.

There is a problem in that the number of lines connected onto the substrate increases as the number of light sources provided in the display apparatus increases, and the complexity of a manufacturing process and costs increase as the number of lines increases.

### SUMMARY

An embodiment of the present disclosure provides a light source device and a display apparatus, the light source device being configured to group a plurality of driving elements into a plurality of scan groups, including one data line and a plurality of scan lines respectively connected to the plurality of scan groups, and configured to determine a transmission time point of a scan signal for each of the scan groups and a cycle of a data signal on the basis of the number of scan groups.

There is provided a light source device including: a plurality of scan groups each respectively including ones of a plurality of driving elements configured to control at least one light source of a plurality of light sources; a plurality of scan lines configured to transmit scan signals to the plurality of scan groups; a data line configured to transmit a data signal to the plurality of scan groups; and a controller configured to determine a generation time point of a scan signal, of the scan signals, and to determine a cycle of the data signal based on a number of scan groups of the plurality of scan groups.

The light source device may further include a carry line connected to the controller and a switch configured to receive a carry signal from the controller through the carry line and transmit the carry signal to the plurality of scan lines.

The switch may be further configured to determine a transmission time point of the carry signal through each of the plurality of scan lines based on the number of scan groups, and at least one of the driving elements included in the plurality of scan groups may be configured to generate the scan signal based on the carry signal being received from the switch, and the at least one of the driving element may be further configured to transmit an on-signal to the light source on a basis of the scan signal.

The switch may be further configured to transmit the carry signal to the plurality of scan lines for each 1/n cycle of a reference cycle based on the number of scan groups being n, the reference cycle may be a cycle of the scan signal, and n may be a natural number.

The controller may be further configured to transmit the data signal to at least one of the driving elements included in the plurality of scan groups based on the cycle of the data signal, and the data signal may include a signal corresponding to a brightness of the at least one light source.

The data line may be connected to the driving elements included in the plurality of scan groups, and the controller may be further configured to transmit the data signal to the driving elements included in the plurality of scan groups based on an order in which the driving elements are connected by the data line.

The controller may be further configured to determine the cycle of the data signal to be equal to or less than 1/n of a reference cycle based on the number of scan groups being n, the controller may be further configured to transmit the data signal through the data line, and n may be a natural number.

Based on the one or more driving elements included in each of the plurality of scan groups being provided as a plurality of the one or more driving elements, the plurality of the one or more driving elements included in a same scan group, of the scan groups, may be connected by a same scan line, of the scan lines, and may be configured to generate the scan signals at an interval of a reference cycle based on an order in which the one or more driving elements are connected by the scan line.

Based on the light sources being connected by the driving elements of the plurality of scan groups, the driving elements connected to the light sources may equally control brightness of the light sources, and the driving elements connected to the light sources may be connected in series.

There is provided a display apparatus including: a plurality of light sources corresponding to a plurality of pixels; a plurality of driving elements respectively connected to the plurality of light sources and grouped into a plurality of data groups and a plurality of scan groups; a plurality of data lines respectively connected to the plurality of data groups; a plurality of scan lines respectively connected to the plurality of scan groups; and a controller configured to determine a generation time point, of a scan signal for each of the plurality of scan groups based on a number of scan groups, and to determine a cycle of a data signal transmitted through the data line, the plurality of data groups each include respective ones of the plurality of scan groups, and an amount of the scan groups included in the plurality of data groups are equal across the data groups.

The display apparatus may further include a carry line connected to the controller; and a switch configured to receive a carry signal from the controller through the carry line and to transmit the carry signal to the plurality of scan lines.

The switch may be further configured to transmit the carry signal to the plurality of scan lines for each 1/n cycle of a reference cycle based on the number of scan groups being n, and the driving elements included in the plurality of scan groups may be configured to generate the scan signal based on the carry signal is received from the switch, at least one of the driving elements may be configured to transmit an on-signal to at least one of the light sources based on the scan signal, and the reference cycle may be a cycle of the scan signal, and n may be a natural number.

The controller may be further configured to determine an electric current, to be applied to the plurality of light sources based on image data to be output through the plurality of pixels, and to transmit the data signal to the driving elements included in the plurality of scan groups and of each of the data groups based on determining the electric current and the cycle of the data signal.

The data lines for each of the data groups may be connected to one or more driving elements, of the plurality of driving elements, included in the plurality of scan groups and of each of the data groups, and the controller may be further configured to transmit the data signal to the one or more of the driving elements based on an order in which the one or more of the driving elements are connected by one or more of the data lines.

The controller may be further configured to determine a cycle of the data signal to be equal to or less than 1/n of a reference cycle based on the number of scan groups being n, and the controller may be further configured to transmit the data signal of the determined 1/n cycle through the data line, and n may be a natural number.

According to the present disclosure, the present disclosure includes the plurality of scan groups including at least one driving element, the plurality of scan lines respectively connected to the plurality of scan groups, and one data line, thereby reducing the number of data lines connected to the substrate of the light source device. Therefore, according to the present disclosure, the lines may be disposed and installed only on one surface of the substrate, which may simplify the process of manufacturing the substrate, easily design the substrate, and reduce the manufacturing costs.

According to the present disclosure, on the basis of the reduction in number of data lines, the cycle of the data signal transmitted through the data line is determined as being shorter than that in the related art, which may maintain the number of gradations capable of expressing the luminance. That is, the present disclosure may reduce the number of lines without reducing the number of gradations capable of expressing the luminance.

The present disclosure may effectively improve the contrast ratio or the brightness ratio of the image by means of local dimming control.

The present disclosure may improve the marketability of the light source device and the display apparatus, improve the user's satisfaction, improve the user's reliability, and ensure the competitiveness of products.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is an external appearance view of a display apparatus according to one or more embodiments;

FIG. 2 is an exploded perspective view of the display apparatus according to one or more embodiments;

FIG. 3 is a cross-sectional view of a display panel provided in the display apparatus according to one or more embodiments;

FIG. 4 is an exemplified view of a light source device provided in the display apparatus according to one or more embodiments;

FIG. 5 is a control configuration view of the display apparatus according to one or more embodiments;

FIG. 6 is an exemplified view of a frame displayed by the display apparatus according to one or more embodiments;

FIG. 7 is an exemplified view illustrating the disposition of a dimming block and a driving element of the light source device provided in the display apparatus according to one or more embodiments;

FIG. 8 is an exemplified view illustrating the disposition of a light source of the light source device provided in the display apparatus according to one or more embodiments;

FIG. 9 is a modified exemplified view illustrating the disposition of the dimming block and the driving element of the light source device provided in the display apparatus according to one or more embodiments;

FIG. 10 is an exemplified view illustrating connection between a scan line, a data line, and a carry line of the light source device provided in the display apparatus according to one or more embodiments;

FIG. 11 is an exemplified view illustrating transmission of a carry signal and a data signal of the light source device provided in the display apparatus according to one or more embodiments;

FIG. 12 is an exemplified view illustrating grouping of a data group and a scan group of the light source device provided in the display apparatus according to one or more embodiments;

FIG. 13 is an exemplified view illustrating transmission of the scan signal and the data signal of the light source device illustrated in FIG. 12;

FIG. 14 is another exemplified view illustrating grouping of the data group and the scan group of the light source device provided in the display apparatus according to one or more embodiments; and

FIG. 15 is an exemplified view illustrating transmission of the scan signal and the data signal of the light source device illustrated in FIG. 14.

### DETAILED DESCRIPTION

Various embodiments of the present document and the terms used in the embodiments are not intended to limit the technical features disclosed in the present document to the particular embodiments and should be understood as including various alterations, equivalents, or alternatives of the corresponding embodiments.

In connection with the description of the drawings, the same or similar reference numerals may be used for the similar or relevant components.

A singular form of a noun corresponding to an item may include one or more of the items, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

If an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

The terms “including,” “having,” and the like are intended to designate the existence of characteristics, numbers, steps, operations, constituent elements, and components described in the present document or a combination thereof, and do not exclude a possibility of the existence or addition of one or more other characteristics, numbers, steps, operations, constituent elements, and components, or a combination thereof in advance.

When one constituent element is “connected to,” “coupled to,” “supported on,” or “in contact with” another constituent element, the constituent elements may be directly connected to, coupled to, supported on, or in contact with each other, and one constituent element may be indirectly connected to, coupled to, supported on, or in contact with another constituent element by means of a third constituent element.

When one constituent element is positioned “on” another constituent element, one constituent element may adjoin another constituent element, and still another constituent element may be present between the two constituent elements.

The term “and/or” includes any and all combinations of a plurality of related and listed components.

Hereinafter, operation principles and embodiments of the present disclosure will be described in detail with reference to the accompanying drawings.

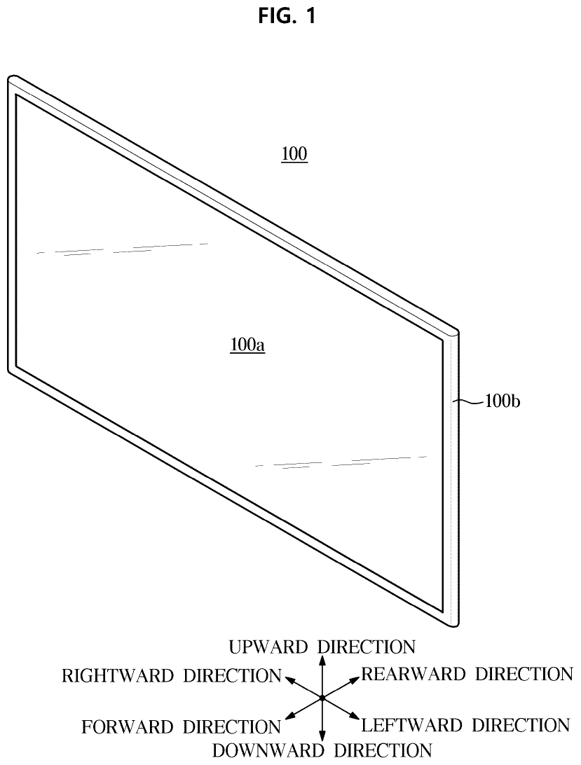

FIG. 1 is an external appearance view of a display apparatus according to one or more embodiments.

The display apparatus 100 may receive content including video signals and audio signals from various content sources and output video and audio corresponding to the video signal and the audio signal. For example, the display apparatus 100 may receive content data through a broadcast receiving antenna or wired cable, receive content data from a content playback device, or receive content data from a content providing server of a content provider.

The display apparatus 100 may include a non-spontaneous light-emitting display apparatus. For example, the non-spontaneous light-emitting display apparatus may include a liquid crystal display apparatus.

The display apparatus 100 may include an outdoor display apparatus (or referred to as a large format display (LFD)) or an indoor display apparatus.

In this case, the outdoor is not necessarily limited to the outside of the buildings and may refer to a place accessed by a large number of people, even indoors, such as subway stations, shopping malls, movie theaters, companies, and stores.

The indoor display apparatuses may include a mini-LED display apparatus and a micro-LED display apparatus.

The display apparatus 100 may include a display of a television (TV), a display of a mobile device, such as a laptop, a smartphone, or a tablet, a monitor of a PC, a display of a household electrical appliance, or a display in a vehicle.

The display apparatus 100 may be a flat display apparatus with a flat screen or a curved display apparatus with a curved screen. The display apparatus 100 may be a variable (bendable or flexible) display apparatus capable of changing a shape of a screen to a flat state or a curved state.

The present disclosure may be applied to various display apparatuses regardless of a screen size, a shape, or a ratio of the display apparatus.

As illustrated in FIG. 1, the display apparatus 100 may include a main body 100a configured to define an external appearance of the display apparatus 100.

The display apparatus 100 may further include a bezel 100b provided on a rim of the main body 100a. The bezel 100b may protect the display apparatus 100 from an external force.

The display apparatus 100 may be implemented as a bezel-less type.

The display apparatus 100 may further include a stand provided below the main body 100a and configured to support the main body 100a while corresponding to an installation environment and function or further include a bracket provided on a rear surface of the main body 100a so that the main body 100a is mounted on a wall surface or the like.

One or more embodiments of the present disclosure will be described with reference to an example in which the display apparatus 100 is a liquid crystal display apparatus that displays images by using light from a light source device.

In this case, the light source device may be a backlight unit.

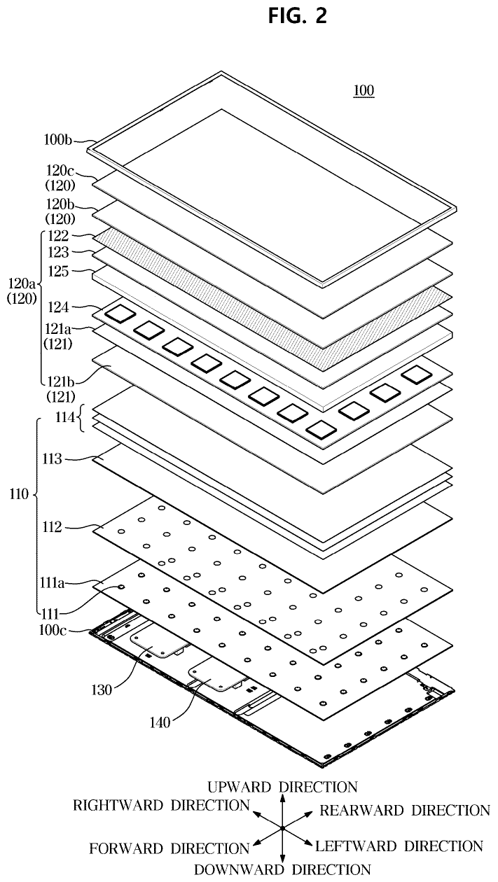

FIG. 2 is an exploded perspective view of the display apparatus according to one or more embodiments.

Hereinafter, for convenience of description, a direction in which an image is displayed by the display apparatus 100 will be referred to as a forward direction, and a direction opposite to the forward direction based on the display apparatus 100 will be referred to as a rearward direction.

As illustrated in FIG. 2, the display apparatus 100 may further include a casing 100c disposed rearward of the main body 100a, coupled to the bezel 100b, and configured to define an external appearance of a rear side of the display apparatus 100.

The display apparatus 100 includes a light source device 110 and a display panel 120 disposed between the bezel 100b and the casing 100c.

Further, the display apparatus 100 may further include a touch panel provided forward of the display panel 120.

The light source device 110 is disposed between the display panel 120 and the casing 100c, disposed to be spaced apart from the display panel 120 at a predetermined distance, and configured to emit light toward the display panel 120. In case that the display panel 120 is a liquid crystal display panel, the light source device 110 may be a backlight unit.

The light source device 110 includes a light source 111, a reflective panel 112, a diffusion panel 113, and an optical sheet 114.

The light source 111 is disposed adjacent to the casing 100c and emits light toward the display panel 120.

The light source 111 may be provided as a plurality of light sources 111. The light source 111 may include a light-emitting diode.

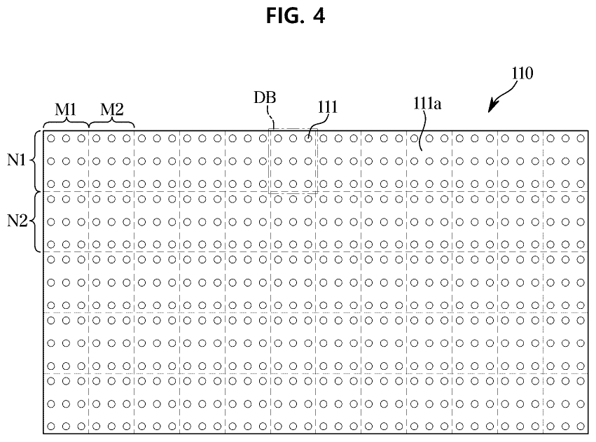

The plurality of light sources may be fixed to and supported on a substrate (see substrate 111a in FIG. 4).

The plurality of light sources may be disposed in a predetermined pattern to emit light with uniform luminance. The plurality of light sources may be disposed to be spaced apart from one another at predetermined distances.

The predetermined pattern may be a square pattern or an equilateral triangular pattern. However, the present disclosure is not limited thereto.

The distances between rows of the plurality of light sources may be equal to one another, and the distances between columns of the plurality of light sources may also be equal to one another.

The plurality of light sources may each adopt an element capable of emitting monochromatic light (light with a particular wavelength, e.g., blue light) or white light (e.g., light made by mixing red light, green light, and blue light) in various directions when electric power is supplied.

For example, the plurality of light sources may include a light-emitting diode (LED).

The substrate of the light source device may supply electric power to the plurality of light sources.

The substrate of the light source device may include a synthetic resin and/or a tempered glass and/or a printed circuit board (PCB).

Various types of lines for supplying electric power to the plurality of light sources may be provided on the substrate of the light source device.

The substrate of the light source device may include the printed circuit board with a plurality of layers.

The reflective panel 112 may be disposed adjacent to the light source 111.

The reflective panel 112 may have a plurality of through-holes into which the plurality of light sources are inserted. That is, the plurality of light sources are inserted and disposed into the through-holes of the reflective panel 112, such that the plurality of light sources may be exposed to the outside.

When a portion of the light emitted from the light source 111 enters the reflective panel 112, the reflective panel 112 reflects the incident light toward the display panel 120. In this case, a portion of the light emitted from the light source 111 may be light emitted toward the casing 100c instead of the display panel or light reflected by the diffusion panel 113.

The reflective panel 112 may be manufactured by using synthetic resin such as polycarbonate (PC) or polyethylene terephthalate (PET) or manufactured by using various metallic materials.

The diffusion panel 113 is a semi-transparent panel disposed between the display panel 120 and the light source 111 of the light source device and configured to diffuse the light emitted from the light source 111 along a surface thereof so that colors and brightness on the entire screen of the display panel 120 are uniformly visible. The diffusion panel 113 improves the luminance of the light emitted from the light source 111.

The light source device 110 may further include one optical sheet 114 or two or more optical sheets 114.

The optical sheet 114 improves optical properties by uniformizing the luminance of the incident light and diffusing the light or collecting high-luminance light.

One of at least two optical sheets 114 improves light transmission efficiency by selectively transmitting the light depending on a wavelength of the light and reflecting light, which is different in wavelength from the selected light, toward the light source device. The optical sheet may include a prism sheet having a prism.

The other of at least two optical sheet 114 may not transmit the light other than the light with a particular wavelength, thereby polarizing the light.

The optical sheet may include a dual brightness enhancement film (DBEF) made by multilayer double refraction coating.

The display panel 120 is a panel disposed in the casing 100c and is configured to convert electrical information into image information by using a change in liquid crystal transmittance rate in response to an applied voltage. The display panel 120 includes a liquid crystal panel 120a, a first polarizing panel 120b, and a second polarizing panel 120c.

The liquid crystal panel 120a may contain liquid crystals and create colors for respective pixels by adjusting a transmittance rate of the transmitted light by changing the arrangement of the liquid crystals.

Images may be implemented by the display apparatus 100 by a combination of colors for the respective pixels formed on the liquid crystal panel 120a.

The liquid crystal panel 120a includes a substrate portion 121, a color filter portion 122, a first electrode portion 123, a second electrode portion 124, and a liquid crystal portion 125.

The substrate portion 121 may include a first substrate 121a and a second substrate 121b attached by sealant.

The color filter portion 122, the first electrode portion 123, the second electrode portion 124, and the liquid crystal portion 125 may be provided between the first substrate 121a and the second substrate 121b.

The first substrate 121a and the second substrate 121b may be glass substrates.

In this case, the first substrate 121a, the second electrode portion 124, the liquid crystal portion 125, the first electrode portion 123, the color filter portion 122, and the second substrate 121b may be sequentially stacked in this order. However, the stacking order is not limited to that in FIG. 2.

The configuration of the liquid crystal panel 120a will be described below in detail.

The first polarizing panel 120b is positioned between the light source device 110 and the liquid crystal panel 120a. When non-polarized light emitted from the light source device 110 enters, the first polarizing panel 120b transmits only the incident light having a first polarization axis. In this case, the light passing through the first polarizing panel 120b may enter the liquid crystal panel 120a.

The second polarizing panel 120c is provided to face the first polarizing panel 120b with the liquid crystal panel 120a interposed therebetween and has a second polarization axis perpendicular to the first polarization axis of the first polarizing panel 120b. That is, the second polarizing panel 120c is disposed on a surface of the liquid crystal panel 120a and polarizes the image light, which is outputted from the liquid crystal panel 120a, in a direction.

The display apparatus 100 may further include a first support member disposed between the diffusion panel 113 and the light source 111 and configured to maintain an interval between the diffusion panel 113 and the light source 111 and fix the diffusion panel 113, and a second support member disposed between the first polarizing panel 120b and the optical sheet 114 and configured to maintain an interval between the first polarizing panel 120b and the optical sheet 114 and fix the diffusion panel 113, the optical sheet 114, and the display panel 120.

The display panel 120 may further include a cable configured to transmit the image data to the display panel 120, and a display driver integrated circuit (DDI) (hereinafter, referred to as a ‘panel driver’) configured to process digital image data and output an analog image signal.

The display apparatus may further include a control assembly 130 and a power source assembly 140 provided in the casing 100c.

The cable of the display panel may electrically connect the control assembly 130 and a panel driver and electrically connect the power source assembly 140 and the panel driver.

The cable of the display panel may include a flexible flat cable, a film cable, or the like that may be bent.

The panel driver may receive image data and electric power from the control assembly 130 and the power source assembly 140 through the cable.

The control assembly 130 may include a control circuit configured to control operations of the display panel 120 and the light source device 110. For example, the control circuit may process video signals and/or audio signals received from an external content source. The control circuit may transmit image data to the display panel 120 and transmit dimming data to the light source device 110.

The power source assembly 140 may include a power circuit configured to supply electric power to the display panel 120 and the light source device 110. The power circuit may supply electric power to the control assembly 130, the display panel 120, and the light source device 110.

The control assembly 130 and the power source assembly 140 may each be implemented by a printed circuit board, and various types of circuits mounted on the printed circuit board. For example, the power circuit may include a condenser, a coil, a resistor element, a processor, and the like, and a power circuit board on which these components are mounted. In addition, the control circuit may include a memory, a processor, and a control circuit substrate on which these components are mounted.

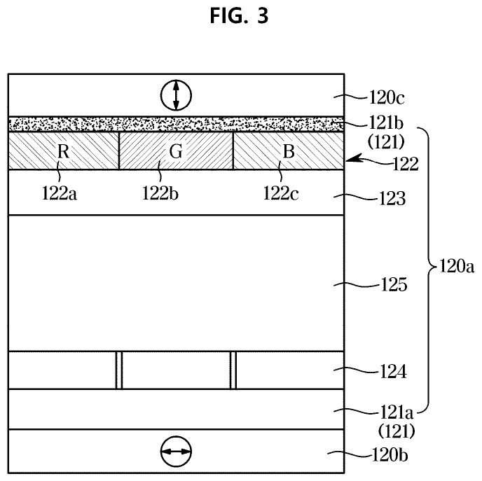

FIG. 3 is a cross-sectional view of the display panel provided in the display apparatus according to one or more embodiments.

The display panel 120 include the liquid crystal panel 120a, the first polarizing panel 120b provided at one side of the liquid crystal panel 120a, and the second polarizing panel 120c provided at the other side of the liquid crystal panel 120a.

The liquid crystal panel 120a includes the substrate portion 121, the color filter portion 122, the first electrode portion 123, the second electrode portion 124, and the liquid crystal portion 125 stacked on one another.

The first substrate 121a of the substrate portion 121 may be provided adjacent to the first polarizing panel 120b.

The first substrate 121a and the second substrate 121b of the substrate portion 121 may support the first electrode portion 123, the second electrode portion 124, and the liquid crystal portion 125 to maintain positions and states of the first electrode portion 123, the second electrode portion 124, and the liquid crystal portion 125.

The substrate portion 121 may include a hard substrate, a flexible substrate, or a rigid flexible substrate or include a glass substrate.

In case that the substrate portion 121 is implemented as a flexible substrate, the display apparatus 100 may be curved while having a predetermined curvature.

The color filter portion 122 may be disposed adjacent to the second polarizing panel 120c or the second substrate 121b.

The color filter portion 122 may be disposed adjacent to the first electrode portion 123.

The color filter portion 122 converts the incident light into red light, green light, and blue light and emits the converted light.

The color filter portion 122 may include a red filter (R), referred to as red filter 122a, configured to convert the incident light into red light, a green filter (G), referred to as green filter 122b, configured to convert the incident light into green light, and a blue filter (B), referred to as blue filter 122c, configured to convert the incident light into blue light.

In this case, the red filter 122a, the green filter 122b, and the blue filter 122c are disposed adjacent to one another and constitute a single RGB filter. Further, the single RGB filter may form a single pixel.

A black matrix may be provided on a boundary of the RGB filter. The black matrix serves as a light-blocking film between the color filters, implements colors, prevents a leak of light, and improves color contrast.

The color filter portion 122 may express a color by emitting, to the outside, at least one of the red light emitted from the red filter 122a, the green light emitted from the green filter 122b, or the blue light emitted from the blue filter 122c or emitting, to the outside, the light made by mixing at least two types of light among the red light emitted from the red filter 122a, the green light emitted from the green filter 122b, and the blue light emitted from the blue filter 122c.

The light converted by each of the filters of the color filter portion 122 may be emitted to the outside through the second polarizing panel 120c.

The first electrode portion 123 may be disposed between the second substrate 121b and the liquid crystal portion 125.

The first electrode portion 123 may be disposed between the color filter portion 122 and the liquid crystal portion 125.

The first electrode portion 123 may be a common electrode that does not include a common slit.

The first electrode portion 123 may be a ground electrode.

A preset reference voltage may be applied to the first electrode portion 123.

The first electrode portion 123 forms an electric field between the first electrode portion 123 and the second electrode portion 124.

The first electrode portion 123 may be configured such that liquid crystal molecules in the liquid crystal portion 125 are oriented by the electric field formed on the liquid crystal portion 125.

The second electrode portion 124 may be disposed adjacent to the first substrate 121a.

The second electrode portion 124 may be disposed between the first substrate 121a and the liquid crystal portion 125.

The second electrode portion 124 includes a pixel electrode configured to form an electric field by using an electrical force of the first electrode portion 123.

The pixel electrode may be provided to correspond to the pixel. The pixel electrode may be provided to correspond to the RGB filter.

The pixel electrode may include a subpixel electrode configured to correspond to the red filter, a subpixel electrode configured to correspond to the green filter, and a subpixel electrode configured to correspond to the blue filter. That is, the subpixel electrodes of the second electrode portion 124 may be disposed to respectively correspond to the positions of the red filter, the green filter, and the blue filter of the color filter portion 122.

Voltages applied to the plurality of subpixel electrodes of the second electrode portion 124 may be equal to or different from one another.

A voltage, which is equal to a reference voltage, or a voltage, which is different from the reference voltage, may be applied to the subpixel electrode.

For example, when the reference voltage is voltage a, a voltage between voltage b and voltage c may be applied to the second electrode portion. Voltage b may be lower than voltage a, and voltage c may be higher than voltage a. Further, voltage a may be any one voltage between voltage b and voltage c.

An electric field may be formed on the liquid crystal portion 125 by a difference between the voltage applied to the subpixel electrode and the voltage applied to the common electrode.

A magnitude of the electric field formed on the liquid crystal portion 125 may be determined depending on the difference between the voltage applied to the subpixel electrode and the voltage applied to the common electrode.

A direction of an electric field line of an electric field formed on the liquid crystal portion 125 may be determined depending on voltages applied to the subpixel electrodes, or no electric field may be formed on the liquid crystal portion 125.

The plurality of subpixel electrodes of the second electrode portion 124 may share the first electrode portion 123.

The second electrode portion 124 may be provided to be opposite to the first electrode portion 123 with the liquid crystal portion 125 interposed therebetween.

The plurality of subpixel electrodes of the second electrode portion 124 may be implemented by using thin-film transistors (TFTs).

The liquid crystal portion 125 may be disposed between the first electrode portion 123 and the second electrode portion 124 and include a plurality of liquid crystals. In this case, the liquid crystal may be a liquid crystal molecule.

The liquid crystals may be arranged inward arbitrarily in case that no electric field is formed. In case that the electric field is formed, the liquid crystals may be oriented in a direction in which the electric field is formed.

FIG. 4 is an exemplified view of the light source device 110 provided in the display apparatus according to one or more embodiments. The light source device 110 in the present embodiment may be a backlight unit.

The light source device 110 may include the plurality of light sources 111 disposed on the substrate 111a and output surface light by diffusing the light emitted from the plurality of light sources 111.

The light source 111 may be a chip-on-board (COB) type light source. The chip-on-board type light sources may be attached directly to the substrate 111a. For example, the light source 111 may include a light-emitting diode in which a light-emitting diode chip or a light-emitting diode die is attached directly to the substrate 111a without separate packaging.

The light source 111 may include a flip chip type light source. The flip chip type light source is made by fusing an electrode pattern of a semiconductor element to the substrate 111a in an intact manner without using an intermediate medium, such as a metal lead (wire), a ball grid array (BGA), or the like when a light-emitting diode, which is a semiconductor element, is attached to the substrate 111a. In this case, because the metal lead (wire) or the ball grid array is excluded, the flip chip type light source may be miniaturized.

The plurality of light sources 111 may be disposed to be spaced apart from one another at preset distances.

The light source device 110 may be divided into a plurality of blocks B. In this case, the divided block will be referred to as a dimming block.

The plurality of dimming blocks B may be disposed in the form of an N*M matrix (N and M are natural numbers). In this case, the N*M matrix may refer to a matrix having N rows and M columns; the N rows including a row N1, a row N2 and so on, and the M columns including a column M1, a column M2, and so on . . .

At least one light source 111 may be provided on each of the plurality of dimming blocks.

In case that the plurality of light sources 111 are respectively provided on the dimming block, the plurality of light sources respectively provided on the plurality of dimming blocks may be disposed to be spaced apart from one another at a first reference distance horizontally and a second reference distance vertically. The light sources may each include the light-emitting diode.

The first reference distance and the second reference distance may be equal to or different from each other.

In case that the plurality of light sources are respectively provided on the dimming blocks, the plurality of light sources 111 respectively provided on the dimming blocks may be connected in series.

Electric currents applied to the plurality of light sources of the dimming blocks may be equal to one another. Therefore, the plurality of light sources of the dimming blocks may emit light beams with the same brightness.

The electric currents applied to the light sources for the respective dimming blocks may be different from one another, and the magnitudes of brightness for the respective dimming blocks may be different from one another.

The display apparatus 100 may perform local dimming control that controls the magnitudes of brightness for the respective dimming blocks of the light source device 110 differently in association with image data.

For example, the display apparatus 100 may decrease the brightness of the light of the dimming block of the light source device 110 corresponding to a dark area of an image by decreasing an electric current to be applied to the dimming block of the light source device 110 corresponding to the dark area of the image. The display apparatus 100 may increase the brightness of the light of the dimming block of the light source device 110 corresponding to a bright area of an image by increasing an electric current to be applied to the dimming block corresponding to the bright area of the image.

Therefore, the display apparatus of the present embodiment may effectively increase a contrast ratio or a brightness ratio of an image.

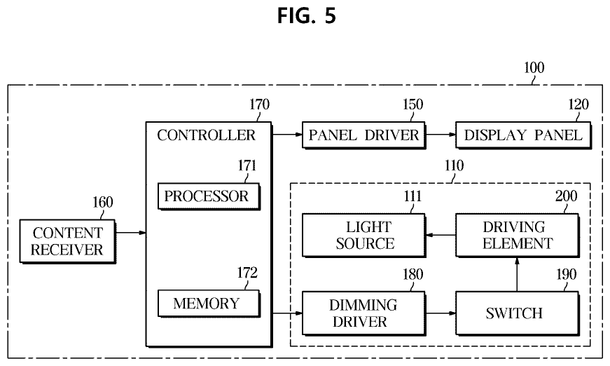

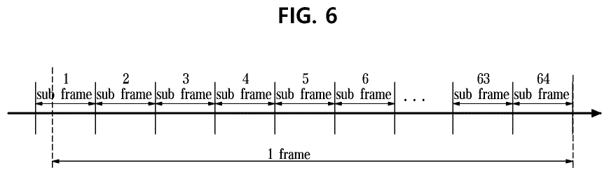

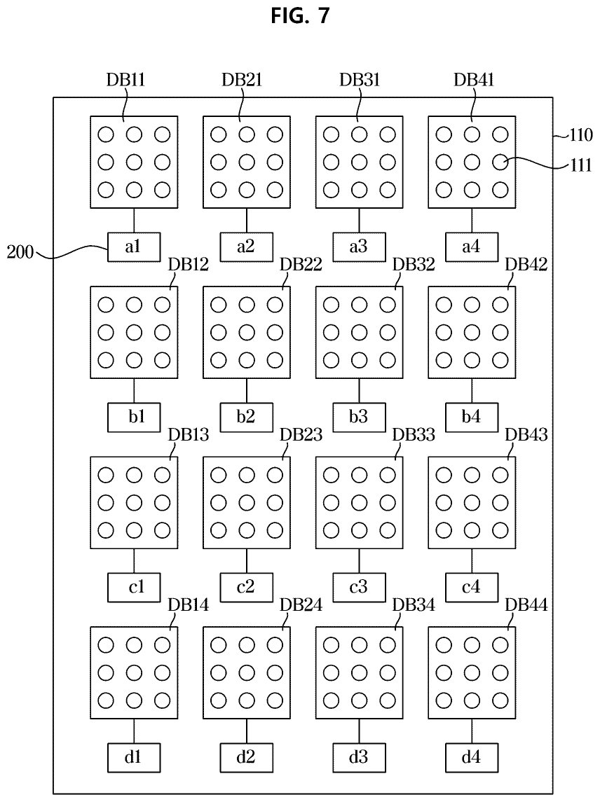

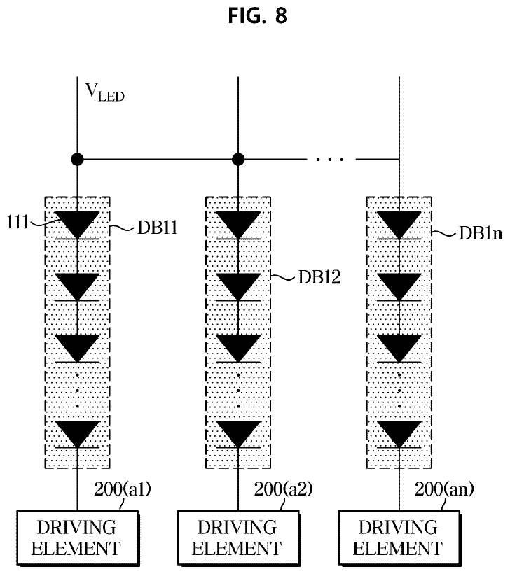

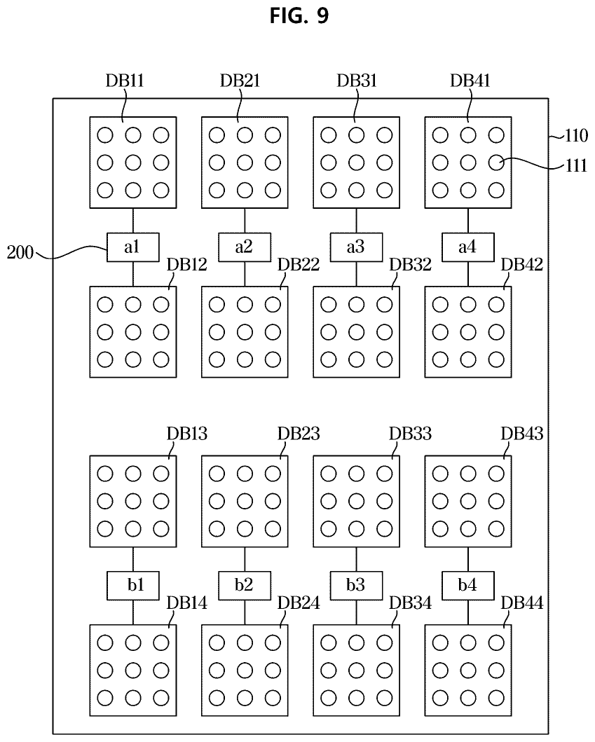

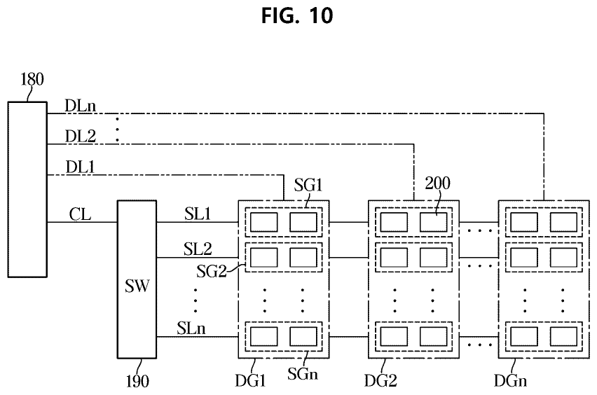

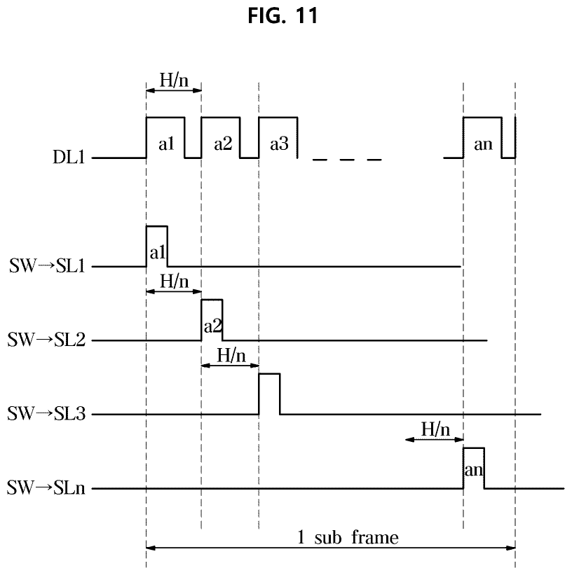

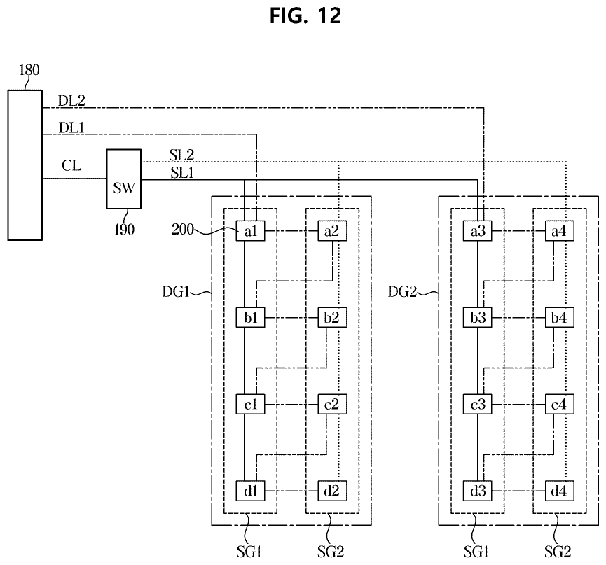

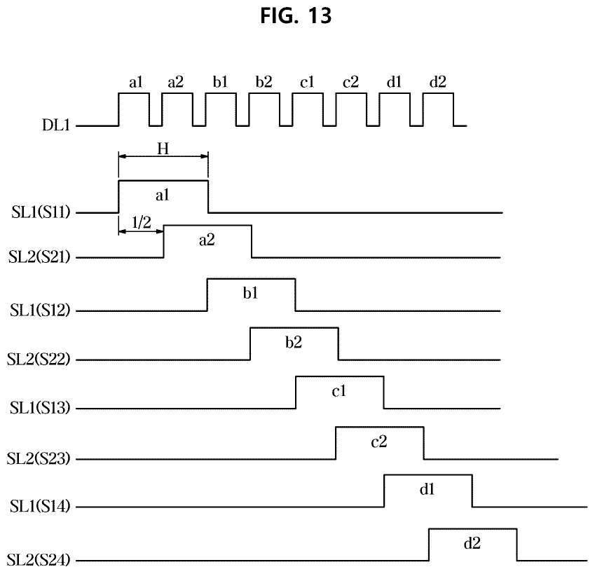

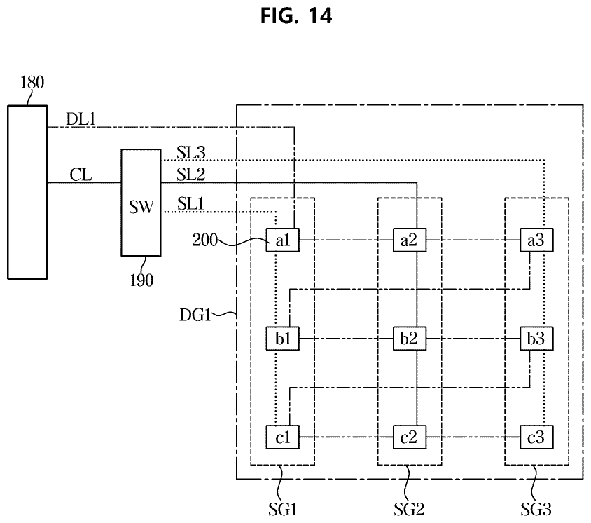

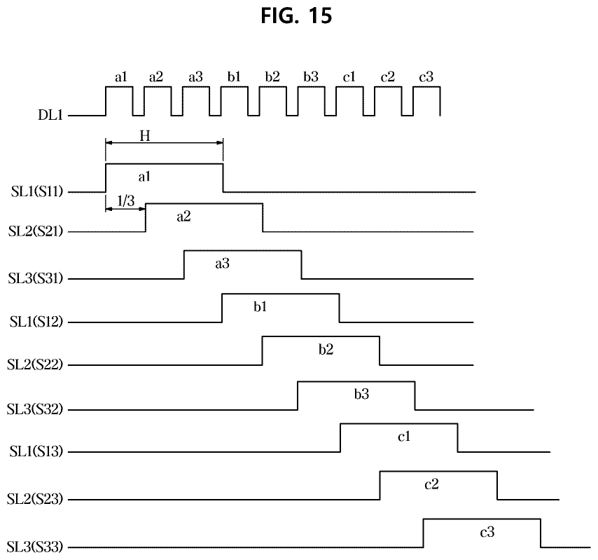

FIG. 5 is a control configuration view of the display apparatus according to one or more embodiments, and the display apparatus according to the embodiment will be described with reference to FIG. 6, FIG. 7, FIG. 8, FIG. 9, FIG. 10, FIG. 11, FIG. 12, FIG. 13, FIG. 14, and FIG. 15.

At least one constituent element may be added or removed in response to performance of the constituent elements of the display apparatus illustrated in FIG. 5. In addition, it may be understood by those skilled in the art that mutual positions of the constituent elements may be changed in response to performance or structure of a system.

Meanwhile, the constituent elements illustrated in FIG. 5 refer to software constituent elements and/or hardware constituent elements such as a field programmable gate array (FPGA) and an application-specific integrated circuit (ASIC).

As illustrated in FIG. 5, the display apparatus 100 may include the light source device 110, the display panel 120, a panel driver 150, a content receiver 160, and a controller 170.

The light source device 110 may include the plurality of light sources 111 configured to emit light, diffuse the light emitted from the plurality of light sources 111, and output the surface light.

The light source device 110 may be divided into the plurality of dimming blocks. In addition, the plurality of dimming blocks may each include at least one light source.

In case that the plurality of light sources are respectively provided on the dimming blocks, the plurality of light sources 111 respectively provided on the dimming blocks may be connected in series.

The light source device 110 may include a dimming driver 180 and a driving element 200 configured to control turning on/off of the light sources for the respective dimming blocks by means of local dimming control or control brightness of the light sources for the respective dimming blocks. The driving element 200 and the dimming driver 180 of the light source device will be described below.

The display panel 120 may be a panel configured to display an image by using the liquid crystals.

The display panel 120 may include a plurality of pixels disposed in the form of a matrix shape. The plurality of pixels may be disposed in a plurality of rows and a plurality of columns.

The display panel 120 may control the plurality of pixels so that the plurality of pixels transmit or block light. Images may be formed by the light passing through the plurality of pixels.

The panel driver 150 may receive image data from the controller 170.

The panel driver 150 may operate the display panel 120 in accordance with the received image data. In other words, the panel driver 150 may convert image data (hereinafter, referred to as ‘digital image data’), which are digital signals, into analog image signals that are analog voltage signals.

The panel driver 150 may provide the converted analog image signal to the display panel 120. Optical properties (e.g., light transmittance) of the plurality of pixels included in the display panel 120 may change in response to the analog image signal.

For example, the panel driver 150 may include a timing controller, a data driver, a scan driver, and the like.

The timing controller may receive the image data from the controller 170.

The timing controller may output the image data and the drive control signal to the data driver and the scan driver.

The drive control signal may include a scan control signal and a data control signal.

The scan control signal and the data control signal may be respectively used to control an operation of the scan driver and an operation of the data driver.

The scan driver may receive the scan control signal from the timing controller.

The scan driver may activate an input of any one row among the plurality of rows on the display panel 120 in response to the scan control signal. In other words, the scan driver may convert the pixels, which are included in any one row among the plurality of pixels disposed in the plurality of rows and the plurality of columns, into a state in which the analog image signal may be received. In this case, the pixels other than the pixels, which have inputs activated by the scan driver, may not receive the analog image signal.

The data driver may receive the image data and the data control signal from the timing controller. The data driver may output the image data to the display panel 120 in response to the data control signal. For example, the data driver may receive the digital image data from the timing controller. The data driver may convert the digital image data into the analog image signal.

In addition, the data driver may provide the analog image signal to the pixels included in any one row input-activated by the scan driver. In this case, the pixels, which have the inputs activated by the scan driver, may receive the analog image signal. The optical properties (e.g., light transmittance) of the pixels having the activated inputs may vary in response to the received analog image signal.

As described above, the panel driver 150 may operate the display panel 120 in accordance with the image data. Therefore, images corresponding to the image data may be displayed on the display panel 120.

The content receiver 160 may receive the content including video signals and/or audio signals from the content sources and transmit the received content to the controller 170.

The content source may include a set-top box, a server, and a mobile device and the like.

The content receiver 160 may receive the content from a storage device provided in the display apparatus or a storage device separably connected to the display apparatus.

The storage device separably connected to the display apparatus may be connected to the display apparatus through a terminal provided in the display apparatus.

The terminals may include a component (YPbPr/RGB) terminal, a composite video blanking and sync (CVBS) terminal, an audio terminal, a high definition multimedia interface (HDMI) terminal, a universal serial bus (USB) terminal, and the like.

The content receiver 160 may include a tuner configured to receive a broadcast signal from a broadcast receiving antenna or a wired cable.

The content receiver 160 may receive the content from the content source through a communication device.

The communication device may perform communication between internal constituent elements of the display apparatus 100 or perform communication with an external device.

The communication device may include a wireless communication module (e.g., a cellular communication module, a short-range wireless communication module, or a global navigation satellite system (GNSS) communication module) or a wired communication module (e.g., a local area network (LAN) communication module or a power line communication (PLC) module).

The short-range wireless communication module may include a Bluetooth communication module, a Bluetooth low energy (BLE) communication module, a near-field communication module, a WLAN (Wi-Fi) communication module, a Zigbee communication module, an infrared data association (IrDA) communication module, a WFD (Wi-Fi Direct) communication module, an ultrawideband (UWB) communication module, an Ant+ communication module, a micro-wave (uWave) communication module, or the like. However, the present disclosure is not limited thereto.

The communication device may communicate with the external device via the first network (e.g., a short-range communication network, such as BLUETOOTH, wireless-fidelity (Wi-Fi) direct, or infrared data association (IrDA)) or the second network (e.g., a long-range communication network, such as a legacy cellular network, a 5th generation (5G) network, a next generation communication network, the Internet, or a computer network (e.g., LAN or WAN).

The controller 170 may create the image data and the dimming data from the video signal received from the content receiver 160.

The controller 170 may transmit the image data to the display panel 120 and transmit the dimming data to the light source device 110.

The image data may include information on an intensity of the light transmitted by the plurality of pixels (or the plurality of subpixels) included in the display panel 120.

The image data may be provided to the display panel 120 via the panel driver 150.

The dimming data may include information on an intensity of the light emitted from the plurality of light sources (or the plurality of dimming blocks) included in the light source device 110. The dimming data may be provided to the light source device 110 via the dimming driver 180. In this case, the intensity of the light may be information corresponding to the brightness of the light.

The controller 170 may divide an image I based on the image data into the plurality of image blocks. The number of image blocks may be equal to the number of dimming blocks, and the plurality of image blocks may respectively correspond to the plurality of dimming blocks.

One image block may include the plurality of pixels, and the image data of one image block may include the image data (e.g., red data, green data, blue data, and the like) of the plurality of pixels.

The controller 170 may calculate a luminance value of each of the pixels on the basis of the image data of the pixels.

For example, the controller 170 may acquire the luminance values of the plurality of dimming blocks on the basis of a maximum value among the luminance values of the pixels included in the image blocks.

In another example, the controller 170 may determine the maximum value, among the luminance values of the pixels included in the image block, as a luminance value of the dimming block of the light source device corresponding to the image block. For example, the controller 170 may determine a maximum value, among the luminance values of the pixels included in an i-th image block, as a luminance value of the i-th dimming block, and the controller 170 may determine a maximum value, among the luminance values of the pixels included in a j-th image block, as a luminance value of the j-th dimming block.

In this case, the luminance value may be information corresponding to the brightness of the light.

The controller 170 may include a processor 171 configured to process the image data, and a memory 172 configured to memorize/store programs and data for processing the image data.

The processor 171 may receive the video signal and/or the audio signal from the content receiver 160. The processor 171 may decode the video signal into the image data.

The processor 171 may create the dimming data from the image data. In addition, the processor 171 may transmit the image data to the panel driver 150 and transmit the dimming data to the dimming driver 180.

As illustrated in FIG. 6, the processor 171 may divide one frame into sixty-four sub-frames, set different electric currents for the respective sub-frames, and create the dimming data, and the processor 171 may transmit the created dimming data to the dimming driver 180. In this case, a sum of the luminance of the sixty-four sub-frames may be equal to overall luminance.

The processor 171 may perform the above-mentioned operation by using data stored in an internal memory of the display apparatus.

The processor 171 may include hardware, such as a CPU or a memory, and software such as a control program. For example, the processor 171 may include an algorithm for controlling operations of the constituent elements in the display apparatus, at least one memory configured to store data in the form of programs, and one or two or more processor chips configured to perform the above-mentioned operations by using the data stored in at least one memory, or the processor 171 may include one or two or more processing cores.

The processor 171 may include a separate NPU configured to perform an operation of an artificial intelligence model and include a graphic-dedicated processor (GPU) or the like.

The memory 172 may store programs and data for processing the video signal and/or the audio signal. In addition, the memory 172 may temporarily memorize the data created while the video signal and/or the audio signal is processed.

The memory 172 may be implemented as at least one of non-volatile memory elements such as a cache, a read-only memory (ROM), a programmable ROM (PROM), an erasable programmable ROM (EPROM), an electrically erasable programmable ROM (EEPROM), or a flash memory, volatile memory elements such as a random access memory (RAM), and storage media such as a hard disk drive (HDD) or a CD-ROM. However, the present disclosure is not limited thereto.

The dimming driver 180 may receive the dimming data from the controller 170.

The dimming driver 180 may be provided integrally with the controller 170.

The dimming driver 180 may transmit the dimming data, which correspond to the input image, to the plurality of driving elements 200 through data lines.

The dimming driver 180 may operate the light source device 110 in accordance with the dimming data. In this case, the dimming data may include information on the luminance of the plurality of dimming blocks or information on the brightness of the light sources included in each of the plurality of dimming blocks.

The dimming driver 180 may convert the dimming data, which are the digital voltage signals, into the analog electric current.

For example, the dimming driver 180 may provide the analog dimming signal sequentially to the driving elements 200 respectively corresponding to the dimming blocks in the form of an active matrix.

The light source device 110 may supply the same electric current to the light sources 111 included in the same dimming block, and the light sources 111 included in the same dimming block may emit light with the same brightness.

For example, the light sources 111 included in the same dimming block may be connected in series. Therefore, the same electric current may be supplied to the light sources 111 included in the same dimming block.

The dimming driver 180 may transmit a carry signal for providing the scan signals to the plurality of driving elements 200, transmit a plurality of data signals for providing the analog dimming data to the plurality of driving elements, and transmit a clock signal.

The carry signal may be transmitted through a carry line, the data signal may be transmitted through a data line, and the clock signal may be transmitted through a data clock line.

The dimming driver 180 may transmit the carry signal, which corresponds to light-emitting time points of the plurality of dimming blocks of the driving element 200, to the driving element. In this case, the dimming driver 180 may transmit the carry signal to a switch 190 through the carry line.

The switch 190 may be connected to the dimming driver 180 through the carry line and connected to the driving elements 200 through the plurality of scan lines.

The switch 190 may transmit the scan signal sequentially to the driving elements 200 through the plurality of scan lines on the basis of the reception of the carry signal.

The driving element 200 may control an electric current to be applied to the light sources, which are included in each of the dimming blocks, on the basis of the scan signal received through the scan line and the data signal received through the data line.

The plurality of driving elements 200 may include various topology circuits in order to implement the operation in the form of an active matrix.

The plurality of driving elements 200 may each include a 1C2T (one capacitor and two transistors) topology circuit. However, the circuit structure of the driving element 200 is not limited thereto. For example, the driving element 200 may include a 3T1C topology circuit to which a transistor for correcting a body effect of a driving transistor is added.

For example, the driving element 200 may be provided as a single chip into which a drive circuit is integrated. In other words, the drive circuit may be integrated into a single semiconductor chip.

The driving elements 200 may each be provided to correspond to at least one dimming block. In other words, the driving elements 200 may each operate at least one dimming block. This will be described with reference to FIG. 7, FIG. 8, and FIG. 9.

FIG. 7 is an exemplified view illustrating the disposition of the dimming block and the driving element of the light source device provided in the display apparatus according to one or more embodiments, and FIG. 8 is an exemplified view illustrating the disposition of the light source of the light source device provided in the display apparatus according to one or more embodiments.

FIG. 9 is a modified exemplified view illustrating the disposition of the dimming block and the driving element of the light source device provided in the display apparatus according to one or more embodiments.

As illustrated in FIG. 7, the driving elements 200 (a1, a2, a3, a4, b1, b2, b3, b4, c1, c2, c3, c4, d1, d2, d3, and d4) may each be connected to one dimming block. The driving elements 200 may each control the brightness of the dimming blocks connected to one another.

As illustrated in FIG. 8, the plurality of dimming blocks may each include the plurality of light sources 111 connected to one another in series.

For example, assuming that one dimming block includes a first light-emitting diode, a second light-emitting diode, a third light-emitting diode, and a fourth light-emitting diode, a positive electrode of the first light-emitting diode may be connected to a power line, a negative electrode of the first light-emitting diode may be connected to a positive electrode of the second light-emitting diode, a negative electrode of the second light-emitting diode may be connected to a positive electrode of the third light-emitting diode, a negative electrode of the third light-emitting diode may be connected to a positive electrode of the fourth light-emitting diode, and a negative electrode of the fourth light-emitting diode may be connected to the driving element 200.

That is, among the plurality of light sources 111 included in one dimming block and connected in series, a first light source 111 of the series connection may be connected to the power line and receive electric power (drive voltage (VLED)), and a last light source 111 of the series connection may be connected to the driving element 200.

In this case, the power line is a line for providing the drive voltage to the plurality of driving elements 200, and the power line may be formed on the substrate 111a.

The driving element 200 may receive the analog dimming signal from the dimming driver 180 while the driving element is input-activated by the dimming driver 180, and the driving element 200 may store the received analog dimming signal. In addition, during the input-deactivation, the plurality of driving elements 200 may supply the electric current, which corresponds to the stored analog dimming signal, to the plurality of light sources (light-emitting diodes) 111.

In a state in which a drive voltage VLED is applied to the plurality of dimming blocks, the driving element 200 may control the electric current to be supplied to the plurality of dimming blocks.

As described above, because the light sources included in the dimming block are connected to one another in series, the light sources included in the dimming block may integrally operate and integrally form the dimming block.

Hereinafter, the configuration in which “the electric current is supplied to the dimming block” may be interpreted as having the same meaning as a configuration in which “the electric current is supplied to the light sources included in the dimming block”.

As illustrated in FIG. 9, the driving elements 200 (driving element a1, driving element a2, driving element a3, driving element a4, driving element b1, driving element b2, driving element b3, and driving element b4) may be respectively connected to the plurality of dimming blocks. The dimming blocks configured to control the driving elements may not overlap one another.

For example, the driving element a1 may be connected to dimming block DB11 and dimming block DB12, the driving element a2 may be connected to dimming block DB21 and dimming block DB22 the driving element a3 may be connected to dimming block DB31 and dimming block DB32, and the driving element a4 may be connected to dimming block DB41 and dimming block DB42.

The driving element b1 may be connected to dimming block DB13 and dimming block DB14, the driving element b2 may be connected to dimming block DB23 and dimming block DB24, the driving element b3 may be connected to dimming block DB33 and dimming block DB34, and the driving element b4 may be connected to dimming block DB43 and dimming block DB44.

FIG. 7 illustrates an example in which one driving element is connected to two dimming blocks. However, one driving element may be connected to three or more dimming blocks.

The driving elements may control the brightness of the plurality of dimming blocks connected to one another.

The plurality of dimming blocks controlled by the same driving element may be grouped into one dimming group.

For example, the dimming block DB11 and the dimming block DB12 may be grouped into a first dimming group, the dimming block DB21 and the dimming block DB22 may be grouped into a second dimming group, the dimming block DB31 and the dimming block DB32 may be grouped into a third dimming group, and the dimming block DB41 and the dimming block DB42 may be grouped into a fourth dimming group. Further, the dimming block DB13 and the dimming block DB14 may be grouped into a fifth dimming group, the dimming block DB23 and the dimming block DB24 may be grouped into a sixth dimming group, the dimming block DB33 and the dimming block DB34 may be grouped into a seventh dimming group, and the dimming block DB43 and the dimming block DB44 may be grouped into an eighth dimming group.

That is, the plurality of dimming blocks may be included for the respective dimming groups.

The electric current is simultaneously supplied to the dimming blocks included in the same dimming group, and the electric current may be supplied sequentially to the dimming blocks included in the different groups at different times.

The dimming driver 180 may activate the dimming blocks included in any one dimming group among the plurality of dimming groups and provide the analog dimming signal to the activated dimming blocks. Thereafter, the dimming driver 180 may activate the dimming blocks included in the different dimming groups and provide the analog dimming signal to the activated dimming blocks.

The drive circuit of each of the dimming blocks may provide the light source device 110 with the analog-type electric current corresponding to the analog dimming signal. With the analog-type electric current, the light sources 111 included in the light source device 110 may emit light.

The light sources included in the same dimming block may emit light with the same intensity on the basis of the dimming data. In addition, the light sources included in the different dimming blocks may emit light with different intensities on the basis of the dimming data.

FIG. 7, FIG. 8, and FIG. 9 merely illustrate examples of connection relationships between the dimming block and the driving elements. However, the connection relationship between the dimming block and the driving elements is not limited thereto.

The display apparatus 100 may include a plurality of scan lines, first scan line SL1, second scan line SL2, and n-th scan line SLn, for providing the scan signals to the plurality of driving elements 200, and a plurality of data lines DL for providing the analog dimming signals to the plurality of driving elements 200. The display apparatus 100 may further include a carry line CL for transmitting the carry signal, and a clock line DCLK for transmitting the clock signal.

The plurality of light sources, the plurality of driving elements, the plurality of data lines, the plurality of scan lines, the power line, and a ground line may be provided on the substrate 111a. In this case, the substrate 111a may be a printed circuit board.

The plurality of driving elements 200 may be connected to the dimming driver 180 and the switch 190 through the plurality of scan lines and the plurality of data lines.

The configuration for connecting the carry line, the scan line, and the data line between the dimming driver 180, the switch 190, and the plurality of driving elements 200 and the configuration for transmitting the carry signal and the data signal will be described with reference to FIG. 10 and FIG. 11.

FIG. 10 is an exemplified view illustrating the connection between the scan line, the data line, and the carry line of the light source device provided in the display apparatus according to one or more embodiments, and FIG. 11 is an exemplified view illustrating the transmission of the carry signal and the data signal of the light source device provided in the display apparatus according to one or more embodiments.

As illustrated in FIG. 10, the plurality of driving elements 200 may be grouped into the plurality of data groups, first data group DG1, second data group DG2, . . . , and n-th data group DGn.

The data groups, first data group DG1, second data group DG2, . . . , and n-th data group DGn, may each include the plurality of driving elements 200.

The plurality of data groups, first data group DG1, second data group DG2, . . . , and n-th data group DGn, may be connected to the different data lines, first data line DL1, second data line DL2, . . . , and n-th data line DLn. For example, a first data group DG1 may be connected to a first data line DL1, a second data group DG2 may be connected to a second data line DL2, and an n-th data group DGn may be connected to an n-th data line DLn.

The plurality of driving elements 200 included in each of the data groups may be connected to the same data line. For example, the driving elements 200 included in the first data group DG1 may be connected to the first data line DL1, the driving elements 200 included in the second data group DG2 may be connected to the second data line DL2, and the driving elements 200 included in the n-th data group DGn may be connected to the n-th data line DLn.

The dimming driver 180 may transmit the data signal to the plurality of data groups, data group DG1, data group DG2, . . . , and data group DGn through the data lines, first data line DL1, second data line DL2, . . . , and n-th data line DLn.

For example, the dimming driver 180 may transmit the data signal to the first data group DG1 through the first data line DL1, transmit the data signal to the second data group DG2 through the second data line DL2, and transmit the data signal to the n-th data group DGn through the n-th data line DLn.

The dimming driver 180 may transmit the data signal having the same data cycle to the plurality of data groups, data group DG1, data group DG2, . . . , and data group DGn at the same time point through the data lines, first data line DL1, second data line DL2, . . . , and n-th data line DLn.

The data signal transmitted through one data line may have a magnitude corresponding to the brightness of the dimming block for each of the driving elements. In this case, the magnitude of the data signal corresponding to the brightness of the dimming block for each of the driving elements may include a value of the electric current for each of the driving element.

For example, the dimming driver 180 may transmit a data signal for an electric current of 3 mA to a first driving element connected to the first data line DL1, transmit a data signal for an electric current of 5 mA to a second driving element connected to the first data line DL1, and transmit a data signal for an electric current of 0 mA to a third driving element connected to the first data line DL1.

The plurality of driving elements 200 included in the data groups, data group DG1, data group DG2, . . . , and data group DGn may be grouped into a plurality of scan groups, first scan group SG1, second scan group SG2, . . . , and n-th scan group SGn.

The respective scan groups may be connected to different scan lines. For example, a first scan group SG1 may be connected to a first scan line SL1, a second scan group SG2 may be connected to a second scan line SL2, and an n-th scan group SGn may be connected to an n-th scan line SLn.

The plurality of driving elements 200 for each of the scan groups may be connected to the same scan line. For example, the driving elements included in the first scan group SG1 may be connected to the first scan line SL1, the driving elements included in the second scan group SG2 may be connected to the second scan line SL2, and the driving elements included in the n-th scan group SGn may be connected to the n-th scan line SLn.

The switch 190 may receive the carry signal from the dimming driver 180 through the carry line CL, transmit the carry signal to the first scan line SL1, the second scan line SL2, and the n-th scan line SLn for each of the data groups, and transmit the carry signal sequentially to the first scan line SL1, the second scan line SL2, and the n-th scan line SLn for each of the data groups.

That is, the switch 190 may transmit the carry signal sequentially to the plurality of scan groups for all the data groups.

The switch 190 may recognize time points at which the carry signals for each of the scan lines are transmitted on the basis of the number of scan groups for each of the data groups. In this case, the number of scan groups for each of the data groups may be constant.

When the number of scan groups included in one data group is n, the switch 190 may transmit the carry signal on the basis of a 1/n cycle of a cycle H of the scan signal.

As illustrated in FIG. 11, the switch 190 may transmit a first carry signal through the first scan line SL1, transmit a second carry signal through the second scan line SL2 at a time point of a 1/n cycle of the cycle H of the scan signal from a time point at which the first carry signal is transmitted, and transmit a third carry signal through the third scan line SL3 at the time point of a 1/n cycle of the cycle of the scan signal from a time point at which the second carry signal is transmitted.

The switch 190 may transmit an (n−1)th carry signal through an (n−1)th scan line and then transmit an n-th carry signal through an n-th scan line at a time point of a 1/n cycle of the cycle of the scan signal from a time point at which the (n−1)th carry signal is transmitted.

In this case, the time point of the 1/n cycle of the cycle H of the scan signal may be a time point at which the time corresponding to the cycle H of the scan signal is 1/n time.

The switch 190 may sequentially transmit the carry signal from the second scan line to the n-th scan line at the time point of a 1/n cycle of the cycle of the scan signal, a 2/n cycle of the cycle of the scan signal, and a (n−1)/n cycle of the scan signal from the time point at which the first carry signal is transmitted through the first scan line SL1 on the basis of the number (n) of scan groups and the cycle H of the scan signal.

In this case, the cycle H of the scan signal may be a preset cycle, i.e., a reference cycle for the scan signal. The cycle H of the scan signal may be the time of approximately 6.5 μ seconds.

The clock line may be connected to each of the plurality of driving elements. The plurality of driving elements may each receive the clock signal through the clock line.

The driving elements included in the same scan group may be connected through the same scan line.

The order in which the driving elements for each of the scan group receive the carry signal may be determined. In this case, the order may be determined depending on the arrangement positions of the driving elements.

That is, the driving elements for each of the scan groups may sequentially receive the carry signal through the same scan line.

The driving elements for each of the scan groups may each generate the scan signal on the basis of the received carry signal and the received clock signal, recognize a transmission time point of the carry signal on the basis of the cycle of the generated scan signal, and transmit the carry signal to the next driving element at the recognized transmission time point of the carry signal.

For example, when the carry signal is received from the (n−1)th driving element, the n-th driving element of the scan group may generate the scan signal on the basis of the received carry signal and the received clock signal, recognize the transmission time point of the carry signal on the basis of the cycle of the received scan signal, and transmit the carry signal to the (n+1)th driving element when the recognized transmission time point of the carry signal is reached.

In this case, the carry signal may be a signal indicating the generation of the scan signal.

The scan signal may be a signal for activating the plurality of driving elements 200. The driving element, which has received the scan signal, may control the electric current to be applied to dimming block on the basis of the dimming data received through the data line.

The data groups may be connected to the different data lines.

The data line may be connected between the driving elements provided in the different scan groups. That is, the data line cannot be connected between the driving elements in the same scan group.

For example, the driving element in an a-th row of the first scan group SG1 may be connected to the driving element in an a-th row of the second scan group SG2, and the driving element in the a-th row of the second scan group SG2 may be connected to the driving element in an (a+1)th row of the first scan group SG1.

The driving element in the a-th row of the first scan group SG1, the driving element in the (a+1)th row, the driving element in the (a+2)th row, and the driving element in the (a+n)th row are not connected by the data line.

The driving element in the a-th row of the second scan group SG2, the driving element in the (a+1)th row, the driving element in the (a+2)th row, and the driving element in the (a+n)th row are also not connected by the data line.

That is, the data line may be connected between the scan groups in the data group.

The driving elements for each of the data groups may transmit the data signal on the basis of the connection order through the data line.

The cycle of the data signal transmitted through the data line connected to each of the scan groups may be shorter than the cycle of the scan signal.

The data signal transmitted through the data line connected to each of the scan groups may be transmitted at the same time point.

The cycle of the data signal transmitted through the data line connected to each of the scan groups may be equal to 1/n of the cycle H of the scan signal or shorter than 1/n of the cycle H of the scan signal. In this case, n may be the number of scan groups included in the same data group. n is a natural number.

The plurality of driving elements for each of the data groups may each transmit a scan signal of an H cycle and a data signal of an H/n cycle to different driving elements for the time for which one sub-frame is outputted.

The scan signal may be a signal for activating the plurality of driving elements 200. The driving element, which has received the scan signal, may control the electric current to be applied to dimming block on the basis of the dimming data received through the data line.

That is, the plurality of driving elements 200 may each be switched by the scan signal to a state, in which the dimming data may be received, and then control the electric current to be applied to the light source in the dimming block on the basis of the data signal received through the data line.

The configuration for connecting the scan line and the data line between the dimming driver 180, the switch 190, and the plurality of driving elements 200 and the configuration for transmitting the scan signal and the data signal will be more specifically described with reference to FIG. 12, FIG. 13, FIG. 14, and FIG. 15.

FIG. 12 is an exemplified view illustrating the grouping of the data group and the scan group of the light source device provided in the display apparatus according to one or more embodiments, and FIG. 13 is an exemplified view illustrating the transmission of the scan signal and the data signal of the light source device illustrated in FIG. 12.

FIG. 12 and FIG. 13 are views illustrating the configuration for connecting the scan line and the data line and the configuration for transmitting the scan signal and the data signal in case that two scan groups are provided in one data group.

As illustrated in FIG. 12, the first data group DG1 may include the plurality of driving elements 200 (driving element a1, driving element a2, driving element b1, driving element b2, driving element c1, driving element c2, driving element d1, and driving element d2) connected to the first data line DL1.

The first data group DG1 may be grouped into two scan groups. That is, the first data group DG1 may include the first scan group SG1 and the second scan group SG2.

The first scan group SG1 included in the first data group DG1 may include the plurality of driving elements 200 (driving element a1, driving element b1, driving element c1,and driving element d1) connected to the first scan line SL1.

The second scan group SG2 included in the first data group DG1 may include the plurality of driving elements 200 (driving element a2, driving element b2, driving element c2, and driving element d2) connected to the second scan line SL2.

The second data group DG2 may include the plurality of driving elements 200 (driving element a3, driving element a4, driving element b3, driving element b4, driving element c3, driving element c4, driving element d3, and driving element d4) connected to the second data line DL2.

The second data group DG2 may be grouped into two scan groups. That is, the second data group DG2 may include the first scan group SG1 and the second scan group SG2. The number of scan groups included in the second data group DG2 may be equal to the number of scan groups included in the first data group DG1.

The first scan group SG1 included in the second data group DG2 may include the plurality of driving elements 200 (driving element a3, driving element b3, driving element c3, and driving element d3) connected to the first scan line SL1. The second scan group SG2 included in the second data group DG2 may include the plurality of driving elements 200 (driving element a4, driving element b4, driving element c4, and driving element d4) connected to the second scan line SL2.

The dimming driver 180 may transmit the data signal to the plurality of driving elements 200 (driving element a1, driving element a2, driving element b1, driving element b2, driving element c1, driving element c2, driving element d1, and driving element d2) included in the first data group DG1 through the first data line DL1.

The dimming driver 180 may transmit the data signal to the plurality of driving elements 200 (driving element a1, driving element a2, driving element b1, driving element b2, driving element c1, driving element c2, driving element d1, and driving element d2) included in the second data group DG2 through the second data line DL2.

The dimming driver 180 may transmit the clock signal to the plurality of driving elements (driving element a1, driving element a2, driving element a3, driving element a4, driving element b1, driving element b2, driving element b3, driving element b4, driving element c1, driving element c2, driving element c3, driving element c4, and driving element d1, driving element d2, driving element d3, and driving element d4) provided in the light source device.

The dimming driver 180 may transmit the carry signal to the switch 190 through the carry line CL.

The switch 190 may transmit the first carry signal through the first scan line SL1 and transmit the second carry signal through the second scan line SL2 on the basis of the received carry signal.

The switch 190 may transmit the first carry signal through the first scan line SL1 on the basis of the received carry signal and then transmit the second carry signal through the second scan line SL2 on the basis of the cycle corresponding to the number of scan groups.

In case that two scan groups for each of the data groups are provided, the switch 190 may transmit the first carry signal through the first scan line SL1 and then transmit the second carry signal through the second scan line SL2 in a 1/2 cycle of the cycle of the scan signal.

The transmission of the first carry signal in case that a driving element a1 (a first driving element), a driving element b1 (a second driving element), a driving element c1 (a third driving element), and a driving element d1 (a fourth driving element) are sequentially connected through the first scan line SL1 will be described. The driving element a1, the driving element b1, the driving element c1, and the driving element d1 may be driving elements disposed in the same column.

As illustrated in FIG. 13, the driving element a1 of the first scan group SG1 may generate a scan signal S11 on the basis of the clock signal received from the dimming driver 180 and the first carry signal received from the switch 190, recognize the transmission time point of the first carry signal on the basis of the cycle of the scan signal, and transmit the first carry signal to the driving element b1 on the basis of the recognized transmission time point of the first carry signal.

That is, the driving element a1 may transmit the first carry signal to the driving element b1 through the first scan line SL1 at a time point at which the cycle of the scan signal S11 ends.

The driving element a1 may transmit an on-signal to the dimming block connected to the driving element a1 during the cycle of the scan signal S11.

The driving element b1 of the first scan group SG1 may generate a scan signal S12 on the basis of the clock signal received from the dimming driver 180 and the first carry signal received from the driving element a1, recognize the transmission time point of the first carry signal on the basis of the cycle of the scan signal, and transmit the first carry signal to the driving element c1 on the basis of the recognized transmission time point of the first carry signal.

That is, the driving element b1 may transmit the first carry signal to the driving element c1 through the first scan line SL1 at a time point at which the cycle of the scan signal S12 ends.

The driving element b1 may transmit an on-signal to the dimming block connected to the driving element b1 in the cycle of the scan signal S12.

The cycles of the scan signals generated by the driving elements may be identical.

The driving element c1 of the first scan group SG1 may generate a scan signal S13 on the basis of the clock signal received from the dimming driver 180 and the first carry signal received from the driving element b1, recognize the transmission time point of the first carry signal on the basis of the cycle of the scan signal, and transmit the first carry signal to the driving element d1 on the basis of the recognized transmission time point of the first carry signal.

That is, the driving element c1 may transmit the first carry signal to the driving element d1 through the first scan line SL1 at a time point at which the cycle of the scan signal S13 ends.

The driving element c1 may transmit an on-signal to the dimming block connected to the driving element c1 in the cycle of the scan signal S13.

The driving element d1 may generate a scan signal S14 on the basis of the clock signal received from the dimming driver 180 and the first carry signal received from the driving element c1 and transmit an on-signal to the dimming block connected to the driving element d1 in the cycle of the generated the scan signal S14.

The transmission of the second carry signal in case that a driving element a2 (a fifth driving element), a driving element b2 (a sixth driving element), a driving element c2 (a seventh driving element), and a driving element d2 (an eighth driving element) are sequentially connected through the second scan line SL2 will be described. The driving element a2, the driving element b2, the driving element c2, and the driving element d2 may be driving elements disposed in the same column.

As illustrated in FIG. 13, the driving element a2 of the second scan group SG2 may generate a scan signal S21 on the basis of the clock signal received from the dimming driver 180 and the second carry signal received from the switch 190, recognize the transmission time point of the second carry signal on the basis of the cycle of the scan signal, and transmit the second carry signal to the driving element b2 on the basis of the recognized transmission time point of the second carry signal.

That is, the driving element a2 may transmit the second carry signal to the driving element b2 through the second scan line SL2 at a time point at which the cycle of the scan signal S21 ends.

The second carry signal received by the driving element a2 may be a carry signal received at a time point of a 1/2 cycle of the cycle of the scan signal from the transmission time point of the first carry signal transmitted to the driving element a1.

The driving element a2 may be a driving element disposed in the same row as the driving element a1.

The driving element a2 may transmit an on-signal to the dimming block connected to the driving element a2 in the cycle of the scan signal S21.

The driving element b2 of the second scan group SG2 may generate a scan signal S22 on the basis of the clock signal received from the dimming driver 180 and the second carry signal received from the driving element a2, recognize the transmission time point of the second carry signal on the basis of the cycle of the scan signal, and transmit the second carry signal to the driving element c2 on the basis of the recognized transmission time point of the second carry signal.

That is, the driving element b2 may transmit the second carry signal to the driving element c2 through the second scan line SL2 at a time point at which the cycle of the scan signal S22 ends.

The driving element b2 may transmit an on-signal to the dimming block connected to the driving element b2 in the cycle of the scan signal S22.

The second carry signal received by the driving element b2 may be a carry signal received at a time point of a 1/2 cycle of the cycle of the scan signal from the transmission time point of the first carry signal transmitted to the driving element b1.

The driving element b2 may be a driving element disposed in the same row as the driving element b1.

The driving element c2 of the second scan group SG2 may generate a scan signal S23 on the basis of the clock signal received from the dimming driver 180 and the second carry signal received from the driving element b2, recognize the transmission time point of the second carry signal on the basis of the cycle of the scan signal, and transmit the second carry signal to the driving element d2 on the basis of the recognized transmission time point of the second carry signal.

That is, the driving element c2 may transmit the second carry signal to the driving element d2 through the second scan line SL2 at a time point at which the cycle of the scan signal S23 ends.

The driving element c2 may be a driving element disposed in the same row as the driving element c1.

The driving element c2 may transmit an on-signal to the dimming block connected to the driving element c2 in the cycle of the scan signal S23.

The second carry signal received by the driving element c2 may be a carry signal received at a time point of a 1/2 cycle of the cycle of the scan signal from the transmission time point of the first carry signal transmitted to the driving element c1.

The driving element d2 may generate a scan signal S24 on the basis of the clock signal received from the dimming driver 180 and the second carry signal received from the driving element c2 and transmit an on-signal to the dimming block connected to the driving element d2 in the cycle of the generated the scan signal S24.

The driving element d2 may be a driving element disposed in the same row as the driving element d1.

The second carry signal received by the driving element d2 may be a carry signal received at a time point of a 1/2 cycle of the cycle of the scan signal from the transmission time point of the first carry signal transmitted to the driving element d1.

Because the configuration for transmitting the carry signal and the scan signal in the second data group DG2 is identical to the configuration for transmitting the carry signal and the scan signal in the first data group DG1, a description thereof will be omitted.

The driving elements included in the first data group DG1 may be connected to the first data line DL1.

The first data line DL1may be connected between the dimming driver and any one driving element in the first data group DG1 and connected between the driving elements provided in the first scan group SG1 and the driving elements provided in the second scan group SG2.

The first data line DL1may be connected between the driving elements in the same scan group. That is, the data line cannot be connected between the driving elements in the first scan group SG1, and the data line cannot be connected between the driving elements in the second scan group SG2.

For example, the first data line DL1may be connected between the dimming driver 180 and the driving element a1 of the first scan group SG1, connected between the driving element a1 of the first scan group SG1 and the driving element a2 of the second scan group SG2, connected between the driving element a2 of the second scan group SG2 and the driving element b1 of the first scan group SG1, connected between the driving element bl of the first scan group SG1 and the driving element b2 of the second scan group SG2, and connected between the driving element b2 of the second scan group SG2 and the driving element c1 of the first scan group SG1.

In addition, the first data line DL1may be connected between the driving element c1 of the first scan group SG1 and the driving element c2 of the second scan group SG2, connected between the driving element c2 of the second scan group SG2 and the driving element d1 of the first scan group SG1, and connected between the driving element d1 of the first scan group SG1 and the driving element d2 of the second scan group SG2.

The dimming driver 180 may transmit the data signal on the basis of the connection order of the first data line DL1of the first data group DG1.

For example, the dimming driver 180 may transmit the data signal in the order of the driving element a1 of the first scan group SG1, the driving element a2 of the second scan group SG2, the driving element b1 of the first scan group SG1, the driving element b2 of the second scan group SG2, the driving element c1 of the first scan group SG1, the driving element c2 of the second scan group SG2, the driving element d1 of the first scan group SG1, and the driving element d2 of the second scan group SG2.

The cycle of the data signal transmitted through the first data line DL1 connected to the first data group DG1 may be shorter than the cycles of the first scan signal and second scan signal of the first scan group SG1 and second scan group SG2.

The cycle of the data signal transmitted through the data line connected to the first scan group SG1 may be equal to 1/n of the cycle H of the first scan signal and second scan signal of the first scan group SG1 and second scan group SG2 or shorter than 1/n of the cycle H of the first scan signal and second scan signal of the first scan group SG1 and second scan group SG2. In this case, n may be the number of scan groups included in the first data group DG1; n is a natural number.

The data signal of the second data line DL2 may be transmitted the same time point as the data signal of the first data line DL1. The cycle of the data signal transmitted through the data line connected to each of the scan groups may be shorter than the cycle of the scan signal.

FIG. 14 is another exemplified view illustrating the grouping of the data group and the scan group of the light source device provided in the display apparatus according to one or more embodiments, and FIG. 15 is an exemplified view illustrating the transmission of the scan signal and the data signal of the light source device illustrated in FIG. 14.

FIG. 14 and FIG. 15 are views illustrating the configuration for connecting the scan line and the data line and the configuration for transmitting the scan signal and the data signal in case that three scan groups are provided in one data group.

The display apparatus may include the plurality of data groups. The configurations for transmitting the carry signals, the scan signals, and the data signals of the plurality of data groups may be identical. Therefore, only the configuration for transmitting the carry signal, the scan signal, and the data signal of the first data group DG1 will be described.

As illustrated in FIG. 14, the first data group DG1 may include the plurality of driving elements 200 (driving element a1, driving element a2, driving element a3, driving element b1, driving element b2, driving element b3, driving element c1, driving element c2, and driving element c3) connected to the first data line DL1.

The first data group DG1 may be grouped into three scan groups. That is, the first data group DG1 may include the first scan group SG1, the second scan group SG2, and a third scan group SG3.

The first scan group SG1 included in the first data group DG1 may include the plurality of driving elements 200 (driving element a1, driving element b1, and driving element c1) connected to the first scan line SL1.

The second scan group SG2 included in the first data group DG1 may include the plurality of driving elements 200 (driving element a2, driving element b2, and driving element c2) connected to the second scan line SL2.

The third scan group SG3 included in the first data group DG1 may include the plurality of driving elements 200 (driving element a3, driving element b3, and driving element c3) connected to the third scan line SL3.

The number of scan groups included in the first data group DG1 may be equal to the number of scan groups included in the remaining data group.

The dimming driver 180 may transmit the data signal to the plurality of driving elements 200 (driving element a1, driving element a2, driving element a3, driving element b1,driving element b2, driving element b3, driving element c1, driving element c2, and driving element c3) included in the first data group DG1 through the first data line DL1.

The dimming driver 180 may transmit the clock signal to the plurality of driving elements (driving element a1, driving element a2, driving element a3, driving element b1, driving element b2, driving element b3, and driving element c1, driving element c2, and driving element c3) provided in the light source device.

The dimming driver 180 may transmit the carry signal to the switch 190 through the carry line CL.

The switch 190 may transmit the first carry signal through the first scan line SL1, transmit the second carry signal through the second scan line SL2, and transmit the third carry signal through the third scan line SL3 on the basis of the received carry signal.

The switch 190 may transmit the first carry signal through the first scan line SL1 on the basis of the received carry signal and then transmit the second carry signal through the second scan line SL2 on the basis of the cycle corresponding to the number of scan groups. The switch 190 may transmit the second carry signal through the second scan line SL2 and then transmit the third carry signal through the third scan line SL3 on the basis of the cycle corresponding to the number of scan groups.

In case that three scan groups are provided in the first data group DG1, the switch 190 may transmit the first carry signal through the first scan line SL1 and then transmit the second carry signal through the second scan line SL2 in a 1/3 cycle of the cycle of the scan signal.

The switch 190 may transmit the second carry signal through the second scan line SL2 and then transmit the third carry signal through the third scan line SL3 in a 1/3 cycle of the cycle of the scan signal.

The switch 190 may transmit the first carry signal through the first scan line SL1 and then transmit the third carry signal through the third scan line SL3 in a 2/3 cycle of the cycle of the scan signal.

The transmission of the first carry signal in case that the driving element a1, the driving element b1, and the third driving element c1 are sequentially connected through the first scan line SL1 will be described. The driving element a1, the driving element b1, and the driving element c1 may be driving elements disposed in the same column on the substrate 111a.

As illustrated in FIG. 15, the driving element a1 of the first scan group SG1 may generate a scan signal S11 on the basis of the clock signal received from the dimming driver 180 and the first carry signal received from the switch 190, recognize the transmission time point of the first carry signal on the basis of the cycle of the scan signal, and transmit the first carry signal to the driving element b1 on the basis of the recognized transmission time point of the first carry signal.

That is, the driving element a1 may transmit the first carry signal to the driving element b1 through the first scan line SL1 at the time point at which the cycle of the scan signal S11 ends.

The driving element a1 may transmit the on-signal to the dimming block connected to the driving element a1 in the cycle of the scan signal S11.

The driving element b1 of the first scan group SG1 may generate the scan signal S12 on the basis of the clock signal received from the dimming driver 180 and the first carry signal received from the driving element a1, recognize the transmission time point of the first carry signal on the basis of the cycle of the scan signal, and transmit the first carry signal to the driving element c1 on the basis of the recognized transmission time point of the first carry signal.

That is, the driving element b1 may transmit the first carry signal to the driving element c1 through the first scan line SL1 at the time point at which the cycle of the scan signal S12 ends.

The driving element b1 may transmit the on-signal to the dimming block connected to the driving element b1 in the cycle of the scan signal S12.

The driving element c1 of the first scan group SG1 may generate the scan signal S13 on the basis of the first carry signal received from the driving element b1 and transmit an on-signal to the dimming block connected to the third driving element in the cycle of the scan signal.

In this case, the cycle of the scan signal may include an on-cycle of the scan signal.

The transmission of the second carry signal in case that a driving element a2, a driving element b2, and a driving element c2 are sequentially connected through the second scan line SL2 will be described. The driving element a2, the driving element b2, and the driving element c2 may be driving elements disposed in the same column on the substrate.

As illustrated in FIG. 15, the driving element a2 of the second scan group SG2 may generate the scan signal S21 on the basis of the clock signal received from the dimming driver 180 and the second carry signal received from the switch 190, recognize the transmission time point of the second carry signal on the basis of the cycle of the scan signal, and transmit the second carry signal to the driving element b2 on the basis of the recognized transmission time point of the second carry signal.

That is, the driving element a2 may transmit the second carry signal to the driving element b2 through the second scan line SL2 at the time point at which the cycle of the scan signal S21 ends.

The second carry signal received by the driving element a2 may be a carry signal received at a time point of a 1/3 cycle of the cycle of the scan signal from the transmission time point of the first carry signal transmitted to the driving element a1.

The driving element a2 may transmit the on-signal to the dimming block connected to the driving element in the cycle of the scan signal S21.

The driving element a2 may be a driving element disposed in the same row as the driving element a1.

The driving element b2 of the second scan group SG2 may generate a scan signal S22 on the basis of the clock signal received from the dimming driver 180 and the second carry signal received from the driving element a2, recognize the transmission time point of the second carry signal on the basis of the cycle of the scan signal, and transmit the second carry signal to the driving element c2 on the basis of the recognized transmission time point of the second carry signal.

That is, the driving element b2 may transmit the second carry signal to the driving element c2 through the second scan line SL2 at a time point at which the cycle of the scan signal S22 ends.

The driving element b2 may transmit the on-signal to the dimming block connected to the driving element in the cycle of the scan signal S22.

The second carry signal received by the driving element b2 may be a carry signal received at a time point of a 1/3 cycle of the cycle of the scan signal from the transmission time point of the first carry signal transmitted to the driving element b1.

The driving element b2 may be a driving element disposed in the same row as the driving element b1.

The driving element c2 of the second scan group SG2 may generate the scan signal S23 on the basis of the clock signal received from the dimming driver 180 and the second carry signal received from the driving element b2 and transmit an on-signal to the dimming block connected to the driving element in the cycle of the scan signal S23.

The driving element c2 may be a driving element disposed in the same row as the driving element c1.

The second carry signal received by the driving element c2 may be a carry signal received at a time point of a 1/3 cycle of the cycle of the scan signal from the transmission time point of the first carry signal transmitted to the driving element c1.

As illustrated in FIG. 15, the driving element a3 of the third scan group SG3 may generate a scan signal S31 on the basis of the clock signal received from the dimming driver 180 and the third carry signal received from the switch 190, recognize the transmission time point of the third carry signal on the basis of the cycle of the scan signal, and transmit the third carry signal to the driving element b3 on the basis of the recognized transmission time point of the third carry signal.

That is, the driving element a3 may transmit the third carry signal to the driving element b3 through the third scan line SL3 at a time point at which the cycle of the scan signal S31 ends.

The third carry signal received by the driving element a3 may be a carry signal received at a time point of a 1/3 cycle of the cycle of the scan signal from the transmission time point of the second carry signal transmitted to the driving element a2.

The third carry signal received by the driving element a3 may be a carry signal received at a time point of a 2/3 cycle of the cycle of the scan signal from the transmission time point of the first carry signal transmitted to the driving element a1.

The driving element a3 may be a driving element disposed in the same row as the driving element a2 and the driving element a1.

The driving element a3 may transmit an on-signal to the dimming block connected to the driving element a3 in the cycle of the scan signal S31.

The driving element b3 of the third scan group SG3 may generate a scan signal S32 on the basis of the clock signal received from the dimming driver 180 and the third carry signal received from the driving element a3, recognize the transmission time point of the third carry signal on the basis of the cycle of the scan signal, and transmit the third carry signal to the driving element c3 on the basis of the recognized transmission time point of the third carry signal.

That is, the driving element b3 may transmit the third carry signal to the driving element c3 through the third scan line SL3 at a time point at which the cycle of the scan signal S32 ends.

The third carry signal received by the driving element b3 may be a carry signal received at a time point of a 1/3 cycle of the cycle of the scan signal from the transmission time point of the second carry signal transmitted to the driving element b2.

The third carry signal received by the driving element b3 may be a carry signal received at a time point of a 2/3 cycle of the cycle of the scan signal from the transmission time point of the first carry signal transmitted to the driving element b1.

The driving element b3 may be a driving element disposed in the same row as the driving element b1 and the driving element b2.

The driving element b3 may transmit an on-signal to the dimming block connected to the driving element b3 in the cycle of the scan signal S32.

The driving element c3 of the second scan group SG2 may generate a scan signal S33 on the basis of the clock signal received from the dimming driver 180 and the third carry signal received from the driving element b3 and transmit an on-signal to the dimming block connected to the driving element c3 in the cycle of the scan signal S33.

The driving element c3 may be a driving element disposed in the same row as the driving element c1 and the driving element c6.

The third carry signal received by the driving element c3 may be a carry signal received at a time point of a 2/3 cycle of the cycle of the scan signal from the transmission time point of the first carry signal transmitted to the driving element c1.

The third carry signal received by the driving element c3 may be a carry signal received at a time point of a 1/3 cycle of the cycle of the scan signal from the transmission time point of the second carry signal transmitted to the driving element c2.

The driving elements included in the first data group DG1 may be connected to the first data line DL1.

The first data line DL1may be connected to the dimming driver and any one driving element in the first data group DG1 and connected between the driving elements in the different scan groups.

The first data line DL1may be connected between the driving elements provided in the first scan group SG1 and the driving elements provided in the second scan group SG2, connected between the driving elements provided in the second scan group SG2 and the driving elements provided in the third scan group SG3, and connected between the driving elements of the third scan group SG3 and the driving elements of the first scan group SG1.

The first data line DL1may be connected between the driving elements in the same scan group. The first data line DL1cannot be connected between the driving elements in the first scan group SG1, cannot be connected between the driving elements in the second scan group SG2, and cannot be connected between the driving elements in the third scan group SG3.

For example, the first data line DL1may be connected between the dimming driver 180 and the driving element a1 of the first scan group SG1, connected between the driving element a1 of the first scan group SG1 and the driving element a2 of the second scan group SG2, connected between the driving element a2 of the second scan group SG2 and the driving element a3 of the third scan group SG3, and connected between the driving element a3 of the third scan group SG3 and the driving element b1 of the first scan group SG1.

In addition, the first data line DL1may be connected between the driving element b2 of the first scan group SG1 and the driving element b2 of the second scan group SG2, connected between the driving element b2 of the second scan group SG2 and the driving element b3 of the third scan group SG3, and connected between the driving element b3 of the third scan group SG3 and the driving element c1 of the first scan group SG1.

In addition, the first data line DL1may be connected between the driving element c1 of the first scan group SG1 and the driving element c2 of the second scan group SG2 and connected between the driving element c2 of the second scan group SG2 and the driving element c3 of the third scan group SG3.

The dimming driver 180 may transmit the data signal on the basis of the connection order of the first data line DL1of the first data group DG1.

For example, the dimming driver 180 may transmit the data signal in the order of the driving element a1 of the first scan group SG1, the driving element a2 of the second scan group SG2, the driving element a3 of the third scan group SG3, the driving element b1 of the first scan group SG1, the driving element b2 of the second scan group SG2, the driving element b3 of the third scan group SG3, the driving element c1 of the first scan group SG1, the driving element c2 of the second scan group SG2, and the driving element c3 of the third scan group SG3.

The cycle of the data signal transmitted through the first data line DL1 connected to the first data group DG1 may be shorter than the cycles of the first scan signal, second scan signal, and third scan signal of the first scan group SG1, second scan group SG2, and third scan group SG3.

The cycle of the data signal transmitted through the first data line DL1may be equal to 1/n of the cycles H of the first, second, and third scan signals or shorter than 1/n of the cycles H of the first, second, and third scan signals. In this case, n may be the number of scan groups included in the first data group DG1. n is a natural number.

The data signal of the data line connected to the remaining data group may be transmitted the same time point as the data signal of the first data line DL1. The cycle of the data signal transmitted through the data line connected to each of the scan groups of the remaining data group may be shorter than the cycle of the scan signal.

The light source device of the present embodiment is a light source device provided in a liquid crystal display apparatus. However, the light source device of the present embodiment is not limited to the light source device provided in the liquid crystal display apparatus.

The light source device of the present embodiment may be applied to a mini-light-emitting diode-based display apparatus, a micro-light-emitting diode-based display apparatus, or an outdoor display apparatus.

In the present embodiment, the driving element for controlling the dimming block including the plurality of light sources has been described. In this case, the object to be controlled by the driving element is not limited to the dimming block. That is, the driving element provided in the light source device of the present embodiment may be applied to the driving element for controlling one light source.

In this case, the driving element connected to the light source may be provided as a plurality of driving elements. The plurality of driving elements may be grouped into the plurality of data groups while corresponding to the connection of the data line, and the data groups may each include the plurality of scan groups while corresponding to the connection of the plurality of scan lines. The display apparatus may determine the generation time point of the scan signal of the driving elements included in each of the scan groups and determine the cycle of the data signal transmitted through the data line on the basis of the number of scan groups in the data group.

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

As described above, the embodiments have been described with reference to the accompanying drawings. A person skilled in the art may understand that the present disclosure may be carried out in other forms different from those disclosed in the embodiments without changing the technical spirit or the essential features of the present disclosure. The disclosed embodiments are illustrative and should not be interpreted as being restrictive.

What is claimed is:

1. A light source device comprising:
a plurality of scan groups each respectively comprising ones of a plurality of driving elements configured to control at least one light source of a plurality of light sources;
a plurality of scan lines configured to transmit scan signals to the plurality of scan groups;
a data line configured to transmit a data signal to the plurality of scan groups; and
a controller configured to determine a generation time point of a scan signal, of the scan signals, and to determine a cycle of the data signal based on a number of scan groups of the plurality of scan groups.

2. The light source device of claim 1, further comprising:
a carry line connected to the controller; and
a switch configured to receive a carry signal from the controller through the carry line and transmit the carry signal to the plurality of scan lines.

3. The light source device of claim 2, wherein the switch is further configured to determine a transmission time point of the carry signal through each of the plurality of scan lines based on the number of scan groups,
wherein at least one of the driving elements included in the plurality of scan groups is configured to generate the scan signal based on the carry signal being received from the switch, and
wherein the at least one of the driving element is further configured to transmit an on-signal to the light source on a basis of the scan signal.

4. The light source device of claim 2, wherein the switch is further configured to transmit the carry signal to the plurality of scan lines for each 1/n cycle of a reference cycle based on the number of scan groups being n,
wherein the reference cycle is a cycle of the scan signal, and
wherein n is a natural number.

5. The light source device of claim 1, wherein the controller is further configured to transmit the data signal to at least one of the driving elements included in the plurality of scan groups based on the cycle of the data signal, and
wherein the data signal comprises a signal corresponding to a brightness of the at least one light source.

6. The light source device of claim 5, wherein the data line is connected to the driving elements included in the plurality of scan groups, and
wherein the controller is further configured to transmit the data signal to the driving elements included in the plurality of scan groups based on an order in which the driving elements are connected by the data line.

7. The light source device of claim 5, wherein the controller is further configured to determine the cycle of the data signal to be equal to or less than 1/n of a reference cycle based on the number of scan groups being n,
wherein the controller is further configured to transmit the data signal through the data line, and
wherein n is a natural number.

8. The light source device of claim 1, wherein based on the one or more driving elements included in each of the plurality of scan groups being provided as a plurality of the one or more driving elements, the plurality of the one or more driving elements included in a same scan group, of the scan groups, are connected by a same scan line, of the scan lines, and are configured to generate the scan signals at an interval of a reference cycle based on an order in which the one or more driving elements are connected by the scan line.

9. The light source device of claim 1, wherein based on the light sources being connected by the driving elements of the plurality of scan groups, the driving elements connected to the light sources equally control brightness of the light sources, and
the driving elements connected to the light sources are connected in series.

10. A display apparatus comprising:
a plurality of light sources corresponding to a plurality of pixels;
a plurality of driving elements respectively connected to the plurality of light sources and grouped into a plurality of data groups and a plurality of scan groups;
a plurality of data lines respectively connected to the plurality of data groups;
a plurality of scan lines respectively connected to the plurality of scan groups; and
a controller configured to determine a generation time point, of a scan signal for each of the plurality of scan groups based on a number of scan groups, and to determine a cycle of a data signal transmitted through the data line,
wherein the plurality of data groups each comprise respective ones of the plurality of scan groups, and
wherein an amount of the scan groups included in the plurality of data groups are equal across the data groups.

11. The display apparatus of claim 10, further comprising:
a carry line connected to the controller; and
a switch configured to receive a carry signal from the controller through the carry line and to transmit the carry signal to the plurality of scan lines.

12. The display apparatus of claim 11, wherein the switch is further configured to transmit the carry signal to the plurality of scan lines for each 1/n cycle of a reference cycle based on the number of scan groups being n, the driving elements included in the plurality of scan groups are configured to generate the scan signal based on the carry signal is received from the switch,
wherein at least one of the driving elements is configured to transmit an on-signal to at least one of the light sources based on the scan signal,
wherein the reference cycle is a cycle of the scan signal, and
wherein n is a natural number.

13. The display apparatus of claim 11, wherein the controller is further configured to determine an electric current, to be applied to the plurality of light sources based on image data to be output through the plurality of pixels, and to transmit the data signal to the driving elements included in the plurality of scan groups and of each of the data groups based on determining the electric current and the cycle of the data signal.

14. The display apparatus of claim 13, wherein the data lines for each of the data groups are connected to one or more driving elements, of the plurality of driving elements, included in the plurality of scan groups and of each of the data groups, and
wherein the controller is further configured to transmit the data signal to the one or more of the driving elements based on an order in which the one or more of the driving elements are connected by one or more of the data lines.

15. The display apparatus of claim 13, wherein the controller is further configured to determine a cycle of the data signal to be equal to or less than 1/n of a reference cycle based on the number of scan groups being n,
wherein the controller is further configured to transmit the data signal of the determined 1/n cycle through the data line, and
wherein n is a natural number.
